(19) United States
(12) Patent Application Publication
(10) Pub. No.: US 2009/0209216 A1
(43) Pub. Date: Aug. 20, 2009

(54) REFLECTOR FOR WIRELESS TELEVISION TRANSMISSIONS

(75) Inventors: Brant Candelore, San Diego, CA (US); Behram Mario DaCosta, San Diego, CA (US); Robert Hardacker, Escondido, CA (US); James R. Milne, Ramona, CA (US); Keith Resch, San Diego, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignees: SONY CORPORATION, Tokyo (JP); SONY ELECTRONICS, INC., Park Ridge, NJ (US)

(21) Appl. No.: 12/034,538

(22) Filed: Feb. 20, 2008

(51) Int. Cl. H04B 1/06

(52) U.S. Cl. 455/130

(57) ABSTRACT

One embodiment of the invention relates to a system for enhancing reception of radio-frequency (RF) signals by an audio-video device such as a high-definition television. The system comprises an audio-video device including a radio-frequency (RF) receiver to receive incoming EF signals, and an RF reflective element. The RF reflective element is positioned to reflect RF signals towards the audio-video device. The RF reflective element is at least partially imbedded with RF reflective materials to reflect undetected, RF signals destined for the audio-video device back to the RF receiver.

### FIELD

Embodiments of the invention are generally directed to the formulation and placement of a specialized apparatus made of radio frequency (RF) reflective material in order to enhance the detected signal strength of RF signals received from a remote HD signaling source.

### GENERAL BACKGROUND

Over the last decade, home networks enabling Internet connectivity have grown in popularity, especially wireless networks. While these networks are currently implemented for computer-based Internet communications, not until recently have wireless networks been used to deliver compressed and uncompressed high-definition (HD) digital television programming.

Over the last few years, companies have attempted to devise and manufacture televisions that are adapted to receive wireless radio-frequency (RF) signals featuring HD television programming. These televisions are implemented with a RF receiver featuring one or more antennas placed within the chassis of the television or standalone receivers with an output to the television. However, depending on the placement of the RF transmitter and the extent of requisite shielding placed within the television or around the standalone receiver for reducing electromagnetic radiation, a large amount of energy may go undetected by the antenna(s) as RF signals propagate through interior and perhaps exterior walls, ceilings and floors of a home.

For instance, interior walls are normally composed of drywall, sometimes referred to as “plaster board”. The drywall comes in sheets that are nailed to the studs and are placed adjacent to each other so as to form a wall. The drywall is made of a paper liner wrapped around an inner core made primarily from gypsum plaster, and thus, it has minimal properties to reflect or absorb propagating RF signals. Similarly, exterior walls may be made of wood and stucco being materials with no RF reflective properties as well.

This lack of recapturing errand RF signals may lead to a temporary interruption in the display of television programming upon experiencing signal loss or an inferior display or audio playback quality due to any reduction in signal strength.

Therefore, it is desirable to create an apparatus that is designed to reflect RF signals, such as wireless high-definition television programming, toward the television or standalone receiver and mitigate RF energy loss.

### BRIEF DESCRIPTION OF THE DRAWINGS

The invention may best be understood by referring to the following description and accompanying drawings that are used to illustrate embodiments of the invention.

FIG. 1 illustrates an embodiment of a home entertainment system featuring a television adapted to receive wireless signals from a remote signaling source.

FIG. 2 is an exemplary embodiment of a television chassis surrounding interior shielding and antennas positioned partially outside the shielding in order to receive wireless signals.

FIG. 3 is a first exemplary embodiment of an RF reflective element designed to reflect wireless signals to one or more antennas integrated within the television as shown in FIG. 2.

FIG. 4 is a second exemplary embodiment of the RF reflective element.

FIG. 5 is a third exemplary embodiment of the RF reflective element being mounted at part of a backside of the chassis of the television of FIG. 2.

FIG. 6 is a fourth exemplary embodiment of the RF reflective element having a sheet of RF reflective material with an adhesive backing.

FIG. 7 is a fifth exemplary embodiment of the RF reflective element integrated within the flooring of the home entertainment system of FIG. 1.

### DETAILED DESCRIPTION

Embodiments of the invention may best be understood by referring to the description in accompanying drawings set forth herein. In general, materials can be described as absorbing, passing, reflecting or scattering radio-frequency waves. According to one embodiment of the invention, an apparatus is described that intentionally reflects radio-frequency (RF) signals, hereinafter referred to as an “RF reflective element,” toward an audio/visual (A/V) device. Hence, the RF reflective element redirects errant RE signals that would have normally passed through a physical barrier of a room (e.g., wall, ceiling, floor, etc.) back to the A/V device. This re-direction of otherwise lost RF signal energy enhances the signal strength at the receiver resulting in enhanced performance.

In the following description, certain terminology is used to describe certain features of one or more embodiments of the invention. For instance, the term “digital content” constitutes information in a digital format including, but not limited or restricted to a digital image, an audio data stream, a video data stream, or an audio-video stream such as high-definition television programming. The term “logic” generally refers to hardware and/or software. For instance, certain types of logic may include an antenna, RF receiver for tuning the antenna in order to detect and recover digital data for subsequent rendering on an A/V device, or the like.

The term “A/V device” is generally defined as an electronic product with a visual display and/or audio playback capability. The electronic product is further adapted with an integrated or external wireless receiver controlling one or more antennas for receipt of wireless signals.

In this detailed description, for clarity sake, the A/V device is illustrated as a high-definition television (e.g., at least 1280 pixels per line and 720 lines per frame resolution) with an integrated wireless receiver. However, it is evident that there are a number of other embodiments for the A/V device, including but not limited or restricted to a standalone receiver which could be attached to the TV via HDMI, a projector or the like.

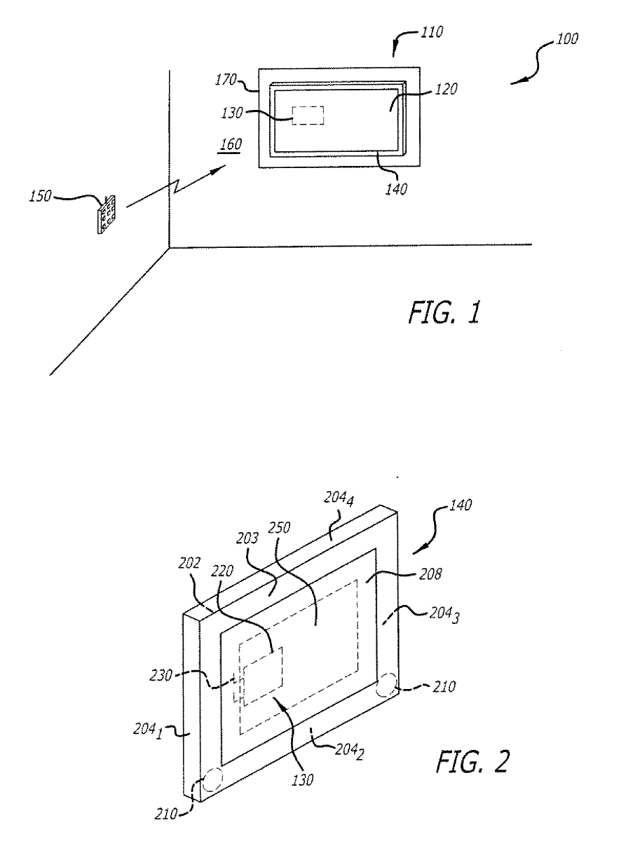

Refer now to FIG. 1, an exemplary embodiment of an entertainment system 100 featuring an audio/visual (A/V) device 110 adapted to receive wireless signals from a signaling source 150 is shown. For this embodiment of the invention, audio/visual (A/V) device 110 is a television such as a flat screen television (e.g., liquid crystal display “LCD” type, a light-emitting diode “LED” type such as OLED, plasma type, etc.) that includes a display 120 controlled by logic 130 that is encased within a television housing 140. A/V device 110 is adapted to receive and process wireless signals, namely radio-frequency “RF” signals, received from a wireless signaling source 150.

As shown in FIG. 1, television 110 is mounted on a back wall 160, but of course, it may be situated in a freestanding position on a horizontal surface. Signaling source 150 (e.g., wireless router, wireless transmitter, a set-top box with wireless signal transmissions, a digital camera or recorder with wireless connectivity, etc.) is adapted to transmit RF signals including digital content such as television programming. The RF signals utilize frequency bands ranging from the megahertz (MHz) to the gigahertz (GHz) or even higher in order to support bandwidth sufficient for transmission of high-definition television programming.

Herein, a RF reflective element 170 is positioned generally “behind” television 110 in order to reflect RP signals that were directed in the vicinity of television 110 but were not detected by its antenna. The order of wireless signaling source 150, television (TV) 110, and reflective element 170 are such that reflective element 170 is designed to reflect energy from wireless signaling source 150 that has progressed beyond television 110 and would otherwise be lost. For instance if the transmitter were directly above television 110, reflective element 170 might be underneath television 110 or if wireless signaling source 150 were in front of television 110, then RF reflector element 170 would be behind television 110. It should be noted that RF reflective element 170 could also be used on side walls, ceilings and floors. These could all aid in reflecting RF signals towards television 110. This might be especially desirable for a room set-up as a home theater.

Special care must be used to make sure that reflective element 170 will not act as a “shield” for RF radiation if wireless signaling source 150 were located in another room that could be behind, to the side, or on a lower floor to the home theater. Generally, RF reflective element 170 would not be placed in between signal source 150 and television 110. As shown, RF reflective element 170 is formed with RF reflective material that can be applied to wall 160. The RF reflective material may have its own adhesive so that it may be attached to wall 160, or the adhesive may be applied separately. An outer side of RF reflective element 170 may be rough or textured in order to receive drywall texture coating. This RF reflecting material includes any electrically conductive material including, but not limited or restricted to metals (e.g., copper, aluminum, tin, silver, gold, etc.) or any polymer composite with conductive additives or coatings. Some of the different applications of RF reflective element 170 are described below.

Refer now to FIG. 2, an illustrative embodiment of A/V device 110 is shown. According to this embodiment, A/V device 110 is a television that comprises a housing 140 features a front panel 200, a back panel 202, and a plurality of side panels 204₁-204₄ that surround and partially encase a display 208. Speakers 210 may be integrated into housing 140 as shown or placed externally from housing 140. In other words, housing 140 operates as a chassis for television 110 in order to protect logic 130 from contaminants and environmental changes that may adversely effect its operation or longevity.

Logic 130 includes a wireless receiver 220 (e.g., a RF receiver) that tunes one or more antennas 230 to receive wireless signals and recover digital content from these wireless signals for transfer to internal data processing circuitry. The internal data processing circuitry is adapted to control the backlighting or illumination of picture elements within display 208.

Radiation shielding 250 is arranged in front of components of logic 130 in order to limit the amount of electromagnetic radiation that escapes housing 140, especially toward the viewer. Exposed from shielding 250 is an antenna structure 230 that may feature one or more antennas positioned in order to receive wireless signals from signaling source 150 of FIG. 1. Antenna(s) 230 is(are) positioned so that shielding 250 does not shadow (i.e., block) them from receiving RF signaling from signaling source 150.

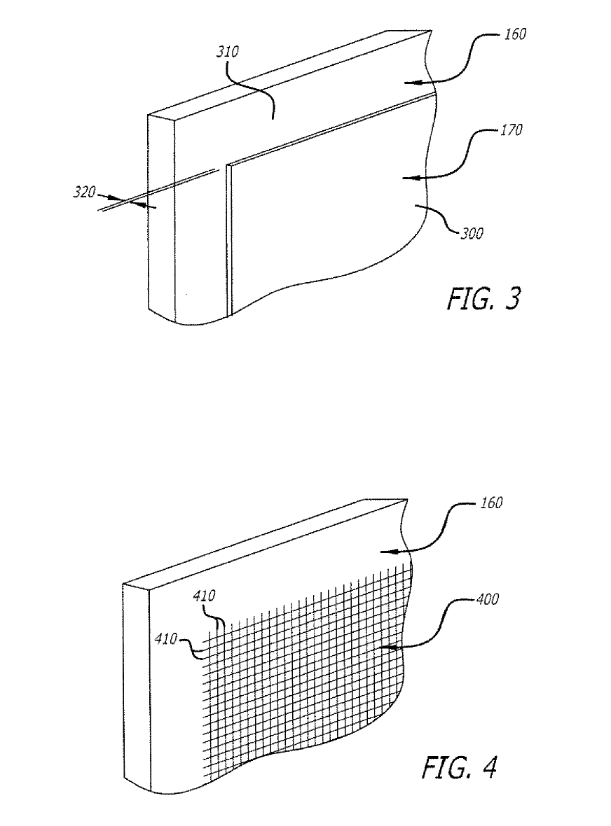

Refer now to FIG. 3, a first illustrative embodiment of RF reflective element 170 is shown. Herein, the RF reflecting element is a film 300 that contains RF reflective material as additives. As an illustrative example, film 300 may include metal filament and is applied to the top surface 310 of wall 160 over which the television is positioned. Film 300 may be applied to an area of wall 160 exceeding the perimeter of television housing 140 or may be applied to selective areas of wall 160 covered by television housing 140 of FIG. 2. For instance, the area directly behind the antenna(s) 230 can be left uncovered by film 300 in order to avoid shadowing the antennas from receiving RF signals propagating through wall 160.

According to one embodiment of the invention, film 300 may be a thin sheet of material (e.g., thin sheet of metal with a thickness 320 being less than three millimeters) that is applied to top surface 310 of wall 160. Alternatively, film 300 may be initially in a gel or liquid state during application, but after drying, film 300 forms a layer of RF reflective material that has adhered to top surface 310 of wall 160.

Refer now to FIG. 4, a second illustrative embodiment of RF reflective element 170 is shown. Herein, the RF reflecting element is a mesh fabric 400 formed with strands 410 of either electrically conductive material or non-conductive material coated with a conductive material. In order to support 60 GHz wireless transmissions or at higher frequencies, it is contemplated that the separation of strands 410 may be 1 millimeter or less.

It is contemplated that both film 300 and mesh fabric 400 may be applied so as to be visible on wall 160 or may be covered by wall covering or paint. Hence, the film 300 or mesh fabric 400 would constitute a layer of wall 160.

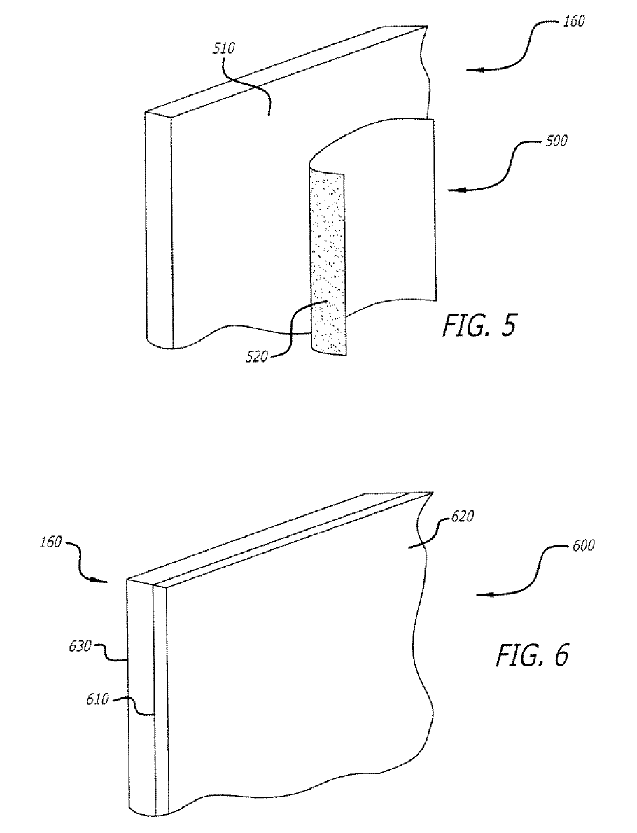

Refer now to FIG. 5, a third embodiment of RF reflective element 170 of FIG. 1 is shown. Herein, RF reflective element 170 is an adhesive backed wall covering 500 that is impregnated with RF reflective material. Of course, in the alternative, the RF reflective material may be simply applied to a top side 510 of wall covering 500. A back side 520 of wall covering 500 includes a pre-installed adhesive or the adhesive may be applied to back side 520 before being applied to wall 160. Wall covering 500 may be applied to an area of wall 160 behind an A/V device in order to assist in the reflection of RF signals from the signaling source or may be applied to selected areas behind the television. Of course, other fastening methods may be used besides an adhesive such as tacks, nails, screws, staples, electrostatic charge, etc.

Refer now to FIG. 6, a fourth illustrative embodiment of RF reflective element 170 of FIG. 1 is shown. Herein, as shown, a sheet of drywall 600 features RF reflective material 610 interposed between a top surface 620 of drywall 600 and a back surface 630 of drywall 600. Of course, it is contemplated that the RF reflective material may be positioned on the top or bottom surfaces of drywall 600 as well. Drywall 600 is attached to studs and form wall 160 in which television 110 is placed. As RF signals arrive at drywall 600, the RF reflective material within drywall causes these signals bounce back toward the back side of the television for detection by an antenna mounted therein. This provides enhanced signal strength for television programming transmitted through wireless communication protocols.

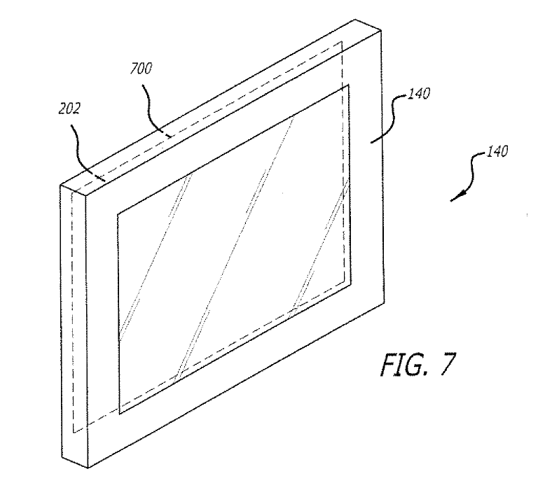

Referring now to FIG. 7, a fifth embodiment of RF reflective element 170 of FIG. 1 is shown. According to this embodiment of the invention, back panel 202 of housing 140 for television 110 features a material 700 with RF reflective characteristics. This RF reflective material may be embedded into the entire back panel 202 or at specified locations along back panel 202. In lieu of being integrated into back panel 202, it is contemplated that RF reflective material 700 may be applied directly on back panel 202 forming the housing of the television in order to allow retrofitting of televisions with RF reflective material to enhance signal strength.

Additionally, it will be evident that various modifications and changes may be made thereto without departing from the broader spirit and scope of the present invention as set forth in the appended claims. For instance, the techniques for enhancing RF reflectivity set forth in FIGS. 3-6 may be performed to walls other than the wall directly behind the television, which was selected for illustrative purposes. Moreover, in lieu of walls, the RF reflective films and mesh of FIGS. 3 and 4 may be placed under the flooring (e.g., under carpet matting or under solid flooring) and the RF reflective elements of FIGS. 3-6 may be performed on the ceiling. Therefore, the specification and drawings are accordingly to be regarded in an illustrative rather than in a restrictive sense.

What is claimed is:

1. An apparatus comprising:
a radio frequency (RF) reflective element being at least partially imbedded with RF reflective materials to reflect a RE signal destined for but undetected by a RF receiver of an audio-video device back to the RF receiver.

2. The apparatus of claim 1 wherein the RF reflective element is implemented within an entertainment system including the audio-video device and a RF transmitter where the audio-video device is positioned between the RF reflective element and the RF transmitter.

3. The apparatus of claim 1 wherein the RF reflective element is a film applied to a structure supporting the audio-video device.

4. The apparatus of claim 1 wherein the RF reflective element is a mesh applied to a structure supporting the audio-video device.

5. The apparatus of claim 1 wherein the RF reflective material comprises an electrically conductive material including either a metal or a polymer composite with a metal coating.

6. The apparatus of claim 1, wherein the RF reflective element comprises a sheet of drywall with a layer of electrically conductive material placed on or within the sheet of drywall.

7. The apparatus of claim 1, wherein the RF reflective element comprises a wall covering impregnated with electrically conductive material, the wall covering including a backing with adhesive.

8. The apparatus of claim 1, wherein the RF reflective element comprises:
a foam pad to be used beneath a carpet, the foam pad including a top surface and a bottom surface; and
an electrically conductive, RF reflective material that may be attached to the top surface or the bottom surface of the foam pad to enhance reflection of the RF signals propagating into the carpet.

9. The apparatus of claim 1, wherein the RF reflective element is attached to a top surface of a cement slab that may be used to enhance reflection of the RF signals propagating into the sheet of cement slab.

10. The apparatus of claim 2, wherein the audio-video device implemented within the entertainment system comprises a high-definition television with the RF receiver adapted to receive high-definition television programming as RF signals.

11. An apparatus comprising:
a sheet of drywall made of a paper liner wrapped around an inner core made of an electrically non-conductive material; and
RF reflective material attached to the sheet of drywall to enhance reflection of radio-frequency (RF) signals propagating into the sheet of drywall.

12. The apparatus of claim 11 wherein the RF reflective material is attached as a layer to a top surface of the sheet of drywall.

13. The apparatus of claim 11 wherein the RF reflective material is imbedded within the sheet of drywall between a top surface and a back surface of the sheet of drywall.

14. The apparatus of claim 11 wherein the RF reflective material is attached as a layer to a back surface of the sheet of drywall.

15. A method comprising:
receiving incoming radio-frequency (RF) signals by a radio-frequency (RF) receiver; and
reflecting a RF signal destined for but undetected by the RF receiver operating for an audio-video device by an RF reflective element, the RF reflective element being positioned behind, at a side, below or above the audio-video device and being at least partially imbedded with RF reflective material to reflect the RF signal.

16. The method of claim 15, wherein positioning of the RF reflective element comprises applying a textured film to a structure supporting the audio-video device.

17. The method of claim 15, wherein the RF reflective material comprises an electrically conductive material including either a metal or a polymer composite with a metal coating.

18. The method of claim 15, wherein the RF reflective element comprises a sheet of drywall with a layer of electrically conductive material placed on or within the sheet of drywall.

19. The method of claim 15, wherein the RF reflective element comprises a wall covering impregnated with electrically conductive material, the wall covering including a backing with adhesive.
